(19) United States
(12) Patent Application Publication
(10) Pub. No.: US 2007/0003390 A1
(43) Pub. Date: Jan. 4, 2007

(54) PIN AND GROMMET FASTENER WITH HIGH FASTENING STRENGTH, AND AIRBAG ATTACHED TO VEHICLE BODY BY SUCH FASTENER

(76) Inventor: Yasuhiro Kawai, Toyohashi-shi (JP)

Correspondence Address: MILES & STOCKBRIDGE PC, 1751 PINNACLE DRIVE, SUITE 500, MCLEAN, VA, 22102-3833, US

(21) Appl. No.: 11/422,420

(22) Filed: Jun. 6, 2006

(30) Foreign Application Priority Data
Jun. 6, 2005 (JP) 2005-165264

(51) Int. Cl. F16B 13/06

(52) U.S. Cl. 411/48

(57) ABSTRACT

A pin and grommet fastener provides high enough fastening strength to resist both longitudinal and transverse detachment forces tending to separate the fastener from workpieces. The pin has a head with depending legs, and the grommet has a shank with slots to receive respective legs passed through holes in a flange of the grommet. The shank has a strong axial column. Pawls on the grommet shank are held against movement inward of the shank by engagement with respective legs of the pin. The fastener can be used to mount a curtain shield airbag on a car body panel, for example.

### CROSS-REFERENCE TO RELATED APPLICATION

This application claims the benefit of Japanese Application No. 2005-165264 filed Jun. 6, 2005, incorporated herein by reference.

### BACKGROUND OF THE INVENTION

Pin and grommet fasteners for joining panels and/or for mounting various types of members on panels are well known. See, for example, Unexamined Japanese Utility Model Application Publication No. 1-85509 (Patent Document 1), U.S. patent application Publication No. US2005/0062263 (Patent Document 2), Unexamined Japanese Patent Application Publication No. 2000-240624 (Patent Document 3), and U.S. patent application Publication No. US2004/0247410 (Patent Document 4). For certain applications, for example attaching a curtain shield airbag to a body panel of a vehicle, it is desirable that such fasteners be strong enough to resist detachment forces in both vertical and horizontal directions with respect to workpieces.

### BRIEF DESCRIPTION OF THE INVENTION

The present invention provides an improved pin and grommet fastener that can be fastened to workpieces, such as panels, with high enough fastening strength to resist both vertical and horizontal detachment forces. The invention provides a fastener (clip) that can provide high fastening strength to a thin panel and that can effectively prevent deformation of the thin panel. More particularly, the invention can provide secure attachment of a curtain shield airbag to a body panel of a vehicle.

In a preferred embodiment, a fastener of the invention comprises a pin having a head and a plurality of legs depending from the head, and a grommet having a flange and a shank depending from the flange. In use, the pin is pushed into the grommet. The shank of the grommet has longitudinal slots for receiving respective legs of the pin when the pin is pushed into the grommet, and has resilient pawls for engaging corresponding regions near edges of a mounting hole in a workpiece (e.g., a car body panel) when the grommet shank is inserted into the mounting hole. The grommet shank has a strong central axial column, the cross-section of which occupies most of the cross-section of the grommet shank. When the pin is fully inserted into the grommet shank, legs of the pin engage the axial column of the grommet and also engage respective resilient pawls of the grommet to prevent the pawls from being moved inwardly of the grommet shank. The legs also fill out portions of the grommet shank cross-section not occupied by the axial column. When the grommet shank has a polygonal cross-sectional profile, for example, and is inserted into a matching hole, the cross-section of the grommet shank matches the profile of the hole. By virtue of the invention, high fastening strength is achieved that strongly resists axial and transverse detachment forces applied to the fastener.

### BRIEF DESCRIPTION OF THE DRAWINGS

The invention will be further described in conjunction with the accompanying drawings, which illustrate a preferred (best mode) embodiment, and wherein:

FIG. 1 is a plan view of a pin of a fastener in accordance with the invention;

FIG. 2 is a front elevation view of the pin of FIG. 1;

FIG. 3 is a cross-sectional view taken along line A-A in FIG. 2;

FIG. 4 is a plan view of a grommet of a fastener in accordance with the invention;

FIG. 5 is a front elevation view of the grommet of FIG. 4;

FIG. 6 is a side elevation view of the grommet of FIG. 4;

FIG. 7 is a cross-sectional view of the grommet taken along line B-B in FIG. 5;

FIG. 8 is a side elevation view of a fastener of the invention in which the pin is partially inserted into the grommet;

FIG. 9 is a front elevation view of the fastener in which the pin is fully inserted into the grommet;

FIG. 10 is a cross-sectional view taken along line C-C in FIG. 9;

FIG. 11 is a somewhat diagrammatic view showing a fastener of the invention initially engaged with an attachment member of a curtain shield airbag;

FIG. 12 is a view similar to FIG. 11 showing a fastener of the invention initially engaged with an attachment member of a curtain shield airbag and a body panel of a vehicle; and

FIG. 13 is a view similar to FIG. 12 showing a fastener of the invention mounting an attachment member of a curtain shield airbag on a body panel of a vehicle.

### DETAILED DESCRIPTION OF THE INVENTION

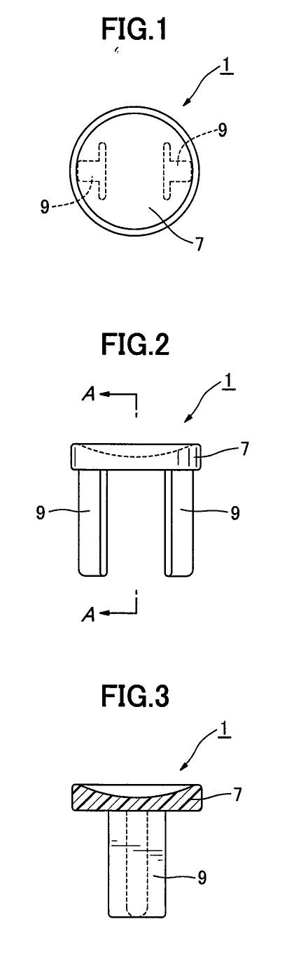

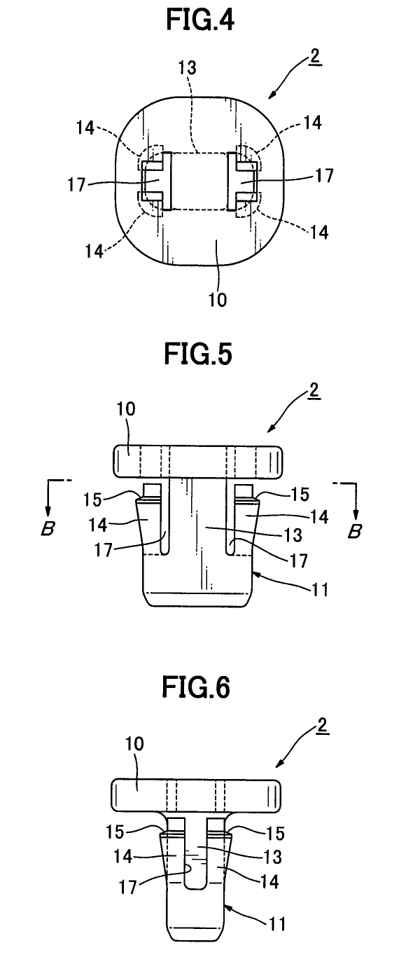

A fastener 3 in accordance with the invention comprises a pin 1 shown in FIGS. 1-3 and a grommet shown in FIGS. 4-7. Each of the pin and the grommet may be an integral plastic molding. The pin has a head 7 of plate-like form and a plurality of depending legs 9. In the embodiment shown, a depression is provided in a top surface of the head 7 of the pin that may be engaged by a fingertip to facilitate pushing the pin into the grommet (as later described). In the embodiment, legs 9 have a T-shaped cross-section. Although two oppositely disposed legs are employed in the embodiment, the invention is not so limited.

The grommet 2 comprises a plate-like flange 10 with a shank 11 depending from the flange. In the embodiment, the shank is polygonal in cross-section, more particularly, generally rectangular. The shank has a strong axial column 13, which in the embodiment is generally rectangular (e.g., square) in cross-section, and a plurality of resilient pawls 14 (e.g., four). In the embodiment, the pawls 14 are fan-shaped in cross-section. In the embodiment, the pawls 14 are hinged to the shank 11 at ends remote from the flange 10 and are separated from the axial column 13 by slots 17, so that the pawls may flex toward and away from the column 13. The ends of the pawls closest to the flange 10 have shoulders 15, which are closely spaced from the flange 10. As later described, the distance between the shoulders 15 and the flange 10 is designed so that an attachment member of a curtain shield airbag (with or without a reinforcement plate) and a body panel of a vehicle can be sandwiched between the shoulders 15 and the flange 10.

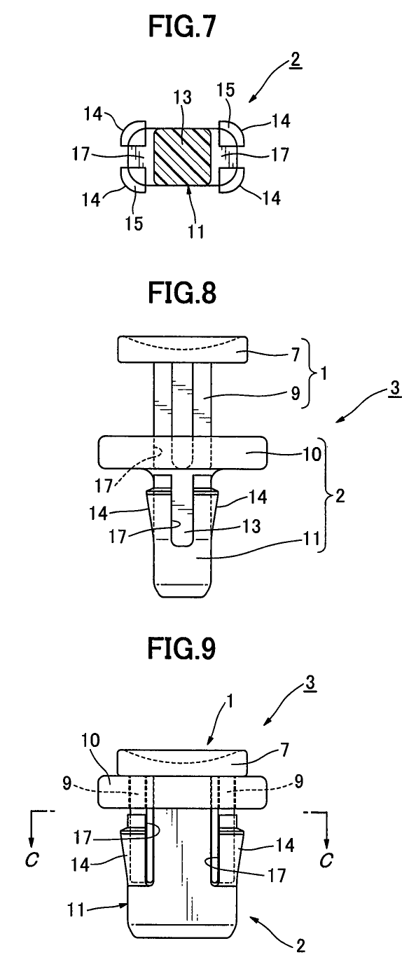

Except for the slots 17, the axial column 13 takes up nearly the entire cross-section of shank 11, to fill up most of the profile of a corresponding hole or holes in workpieces. The legs 9 of the pin take up portions of the cross-section of the shank 11 that are not filled by the axial column 13. This provides high rigidity and high shearing force resistance. In the embodiment, the slots 17 are T-shaped in cross-section to complement the T-shaped cross-section of the legs 9 of the pin. See FIGS. 4 and 7. The flange 10 has holes therethrough that are extensions of the slots 17, so that the legs 9 of the pin can be passed through the flange 10 into the slots 17 in the grommet shank.

FIG. 8 shows the pin 1 partially inserted into the grommet 2. In this position, it is preferred that the pin be temporarily fastened to the grommet, so that the fastener may be easily handled and transported without inadvertent separation of its parts. Such temporary fastening of the pin to the grommet can be achieved, for example, as disclosed in Patent Document 2 by providing internal resilient pawls near the base of the flange 10 that engage grooves in the legs 9 of the pin near their tips. As further disclosed in Patent Document 2, such internal pawls can engage shoulders midway of the legs 9 when the pin is fully inserted into the grommet to a permanent fastening position, so that the pin is held against withdrawal from the grommet.

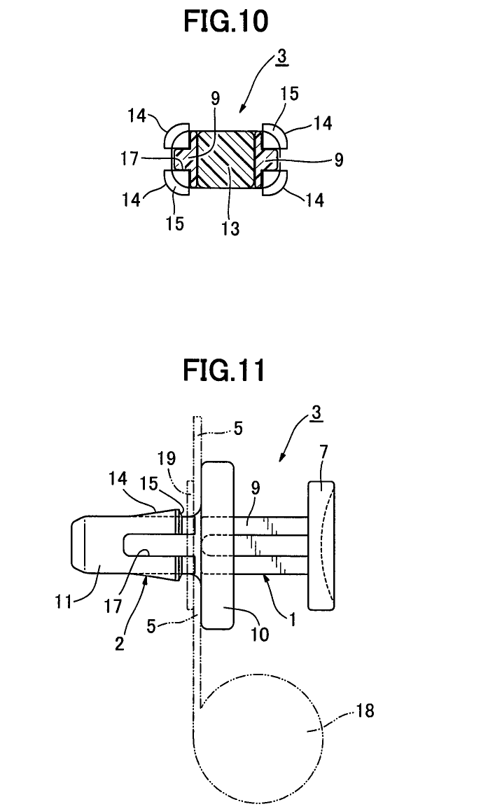

When the pin and the grommet are arranged as shown in FIG. 8, and the head 7 of the pin is pressed toward the flange 10 of the grommet, legs 9 of the pin enter the slots 17 in the shank of the grommet, so that a side of each leg 9 makes contact with the axial column 13 and two sides of each leg make contact with corresponding two sides of two adjacent resilient pawls 14, as shown in FIG. 10. This provides a very stable, rigid assembly of the pin and the grommet, in which the pawls 14 are held against movement inward of the grommet shank.

FIG. 11 shows a fastener 3 of the invention temporarily fastened to an attachment member 5 of a curtain shield airbag 18. In such use, the shank 11 of the grommet 2 is inserted in a mounting hole in the attachment member 5, having a profile that matches the cross-sectional profile of the grommet shank. A reinforcement plate 19 can be provided against the attachment member 5, as shown in FIG. 11, in which case the reinforcement plate will have a hole aligned with the hole in member 5. The thickness of the reinforcement plate 19 can be selected to ensure that a gap between the flange 10 of the grommet 2 and the shoulders 15 of the pawls 14 will be filled when an airbag attachment member 5, a reinforcement plate 19, and a vehicle body panel 6 are sandwiched between the flange 10 and the shoulders 15 of the pawls 14.

With a grommet shank cross-section that is polygonal, a corresponding polygonal hole will be provided in the attachment member 5, the reinforcement plate 19, and the body panel. When the grommet shank 11 is inserted in such holes, the pawls 14 are resiliently flexed inwardly of the shank 11 to permit the shank to be passed through the holes.

By virtue of the temporary attachment arrangement shown in FIG. 11, an assembly comprising a curtain shield airbag with a plurality of fasteners of the invention inserted in corresponding holes of an airbag attachment member and reinforcement plate can be handled as a unit and delivered to a vehicle assembly line for mounting on a body panel, as will now be described.

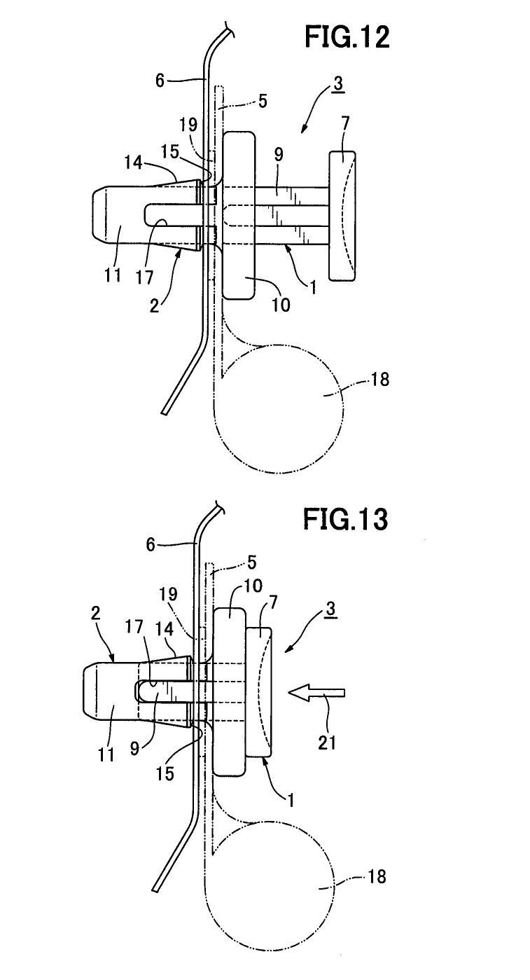

FIG. 12 shows a fastener 3 in accordance with the invention temporarily fastened to an airbag attachment member 5, a reinforcement plate 19, and a vehicle body panel 6. The shank 11 of the grommet 2 is passed through a hole in the body panel 6 aligned with the holes in members 5 and 19. The pawls 14, after being flexed inwardly of the shank 11 for insertion through the aligned holes, then rebound so that the shoulders 15 are disposed to engage regions of the body panel 6 adjacent to the hole through the body panel. If now the pin 1 is pressed in the direction of arrow 21 in FIG. 13 to insert the legs 9 of the pin into the slots 17 in the grommet shank 11 until the head 7 of the pin abuts the flange 10 of the grommet, the attachment member 5, the reinforcement plate 19, and the panel 6 will be permanently sandwiched between the flange 10 and the shoulders 15 of the pawls 14. In the embodiment, the shoulders 15 of the pawls 14 will abut regions of the body panel adjacent to corners of a polygonal hole through the body panel 6. Opposite sides of the axial column 13 will be disposed to engage corresponding edges of the aligned holes and opposite sides of the legs 9 of the pin will be disposed to engage corresponding edges in the aligned holes. With the aligned holes filled up, and pawls 14 prevented from movement inwardly of the grommet shank, very stable and secure attachment of the airbag to the body panel is achieved.

While a preferred embodiment of the invention has been shown and described, changes can be made without departing from the principles and spirit of the invention, the scope of which is defined in the claims which follow. For example, the cross-sectional configuration of the grommet shank and the mounting holes can vary from the rectangular cross-section in the embodiment shown and described. Other polygonal cross-sections can be used, or even rounded cross-sections. The number and positions of resilient pawls and the number and configuration of pin legs can vary appropriately. In any case, it is essential that an axial column of the grommet remain highly rigid and have sufficient strength to withstand both horizontal and vertical detachment forces. When a curtain shield airbag is mounted on a body panel with fasteners of the invention, the fastener must have sufficient strength to withstand strong horizontal shearing force, so that the curtain shield airbag does not come off of the body panel when the airbag is rapidly deployed. Although the fastener embodiment of the invention has been shown and described for use in mounting an airbag on a body panel, other applications of the fasteners are of course possible. For example, fasteners of the invention can be used to replace nuts and bolts or rivets in various fastening applications.

What is claimed is:

1. A fastener comprising:
a pin having a head and a plurality of legs depending from the head; and
a grommet having a flange and a shank depending from the flange,
wherein the grommet shank has a rigid axial column extending from the flange toward a tip of the shank remote from the flange, and has a plurality of resilient pawls supported on the shank for movement inward and outward of the shank in slots, each pawl having a hinged end remote from the flange and having a shoulder at an opposite end, adjacent to the flange, and
wherein the pin and the grommet are constructed so that legs of the pin can be inserted in corresponding slots of the grommet shank as the head of the pin is pressed toward the flange of the grommet and so that predetermined insertion of the legs is effective to prevent inward movement of the resilient pawls.

2. A fastener according to claim 1, wherein predetermined insertion of each leg is effective to prevent inward movement of a pair of the resilient pawls.

3. A fastener according to claim 2, wherein a cross-section of the grommet shank is generally rectangular, and after predetermined insertion, the axial column of the grommet together with the inserted legs of the pin substantially fill the cross-section of the grommet shank.

4. A fastener according to claim 3, wherein each leg is T-shaped in cross-section and the slots in the grommet shank have T-shaped cross-section corresponding to the cross-section of the legs.

5. A fastener according to claim 4, wherein each leg of the pin has two sides that engage corresponding two sides of two of the legs of the pin after predetermined insertion of the legs of the pin.

6. A fastener according to claim 5, wherein the grommet shank is generally rectangular in cross-section, the axial column of the grommet is generally rectangular in cross-sections, and wherein each leg of the pin has a side disposed to engage a corresponding side of the axial column after predetermined insertion.

7. An assembly that includes a fastener according to claim 1 and an attachment member of an airbag, wherein the attachment member is sandwiched between the flange of the grommet and the shoulders of the pawls of the grommet, and the grommet shank extends through a hole in the attachment member.

8. An assembly according to claim 7, wherein a reinforcement plate is sandwiched between the attachment member and the shoulders of the pawls of the grommet and has a hole aligned with the hole in the attachment member.

9. An assembly according to claim 8, wherein the legs of the pin are at least partially inserted into the slots in the grommet.

10. An assembly according to claim 7, wherein a body panel is sandwiched between the attachment member and the shoulders of the pawls of the grommet, the grommet shank extends through a hole in the body panel, and the legs of the pin are at least partially inserted into the slots of the grommet.

11. An assembly according to claim 10, wherein the legs of the pin are fully inserted into the slots of the grommet.

12. An assembly according to claim 11, wherein a reinforcement plate is sandwiched between the attachment member and the body panel, and the grommet shank is inserted through a hole in the reinforcement plate aligned with the holes in the attachment member and the body panel.

13. An assembly according to claim 10, wherein the profile of the holes substantially matches the cross-section of the grommet shank.

14. An assembly according to claim 13, wherein the cross-section of the axial column of the grommet and the cross-sections of the legs of the pin substantially fill the cross-section of the grommet shank after predetermined insertion.

15. An assembly according to claim 14, wherein opposite sides of the axial column of the grommet are disposed to engage corresponding edges of the holes, and opposite sides of a pair of the legs of the pin are disposed to engage corresponding edges of the holes.

16. An assembly according to claim 15, wherein the axial column is rectangular in cross-section, the legs of the pin are T-shaped in cross-section, and the slots of the grommet are T-shaped in cross-section to match the cross-section of the pins.

17. An assembly in which an attachment member of an airbag is mounted on a body panel by a fastener according to claim 2.

18. An assembly in which an attachment member of an airbag is mounted on a body panel by a fastener according to claim 3.

19. An assembly in which an attachment member of an airbag is mounted on a body panel by a fastener according to claim 4.

20. An assembly in which an attachment member of an airbag is mounted on a body panel by a fastener according to claim 5.

21. An assembly in which an attachment member of an airbag is mounted on a body panel by a fastener according to claim 6.
